(19) United States
(12) Patent Application Publication
(10) Pub. No.: US 2018/0010511 A1
(43) Pub. Date: Jan. 11, 2018

(54) INTERNAL COMBUSTION ENGINE

(71) Applicant: TOYOTA JIDOSHA KABUSHIKI KAISHA, Toyota-shi (JP)

(72) Inventor: Teruaki HAIBARA, Kanagawa-ken (JP)

(73) Assignee: TOYOTA JIDOSHA KABUSHIKI KAISHA, Toyota-shi (JP)

(21) Appl. No.: 15/638,574

(22) Filed: Jun. 30, 2017

(30) Foreign Application Priority Data
Jul. 5, 2016 (JP) 2016-133547

(51) Int. Cl. F02B 23/10; F02M 57/06; H01T 13/08; F02P 13/00; H01T 13/52; H01T 13/26

(52) U.S. Cl. CPC F02B 23/101; H01T 13/52; H01T 13/26; H01T 13/08; F02P 13/00; F02M 57/06; F02B 2275/48

(57) ABSTRACT

A fuel injector is configured so that, when seen from a top view of a combustion chamber, a first fuel spray flux and a second fuel spray flux sandwich an electrode part of a spark plug, and the electrode part is located outside of contour surfaces of the two fuel spray fluxes. A first injection angle between a center line of the first fuel spray flux and a vertical line and a second injection angle between a center line of the second fuel spray flux and the vertical line are larger than an angle between a center line of any other fuel spray flux and the vertical line. The second injection angle is made smaller than the first injection angle so that a distance from the electrode part to the contour surface of the second fuel spray flux is larger than a distance from the electrode part to the contour surface of the first fuel spray flux.

### CROSS-REFERENCE TO RELATED APPLICATION

This application is based on and claims the benefit of Japanese Patent Application No. 2016-133547, filed on Jul. 5, 2016, which is incorporated by reference herein in its entirety.

### BACKGROUND

### Field

The present disclosure relates to an internal combustion engine, and particularly relates to an internal combustion engine equipped with a spark plug and a fuel injector on a ceiling of a combustion chamber.

### Background Art

JP2011-117356A discloses an internal combustion engine that is equipped with a spark plug and a fuel injector on a ceiling of a combustion chamber. This internal combustion engine is configured so that an entraining airflow that is generated when fuel is injected from a fuel injector acts on a discharging gap. As shown in FIG. 7 of JP2011-117356A, two fuel spray fluxes are formed from the fuel injector toward the spark plug so as to sandwich an electrode part of the spark plug.

Note that, in addition to the above described patent document, WO2013/008692 may be mentioned as an example of literature describing the state-of-the-art at the time of filing the present application.

### SUMMARY

In the internal combustion engine disclosed in the above patent document, fuel is injected radially obliquely downward from the vicinity of the center of the ceiling of the combustion chamber. To raise an entraining effect by fuel spray flux, an injection angle of the fuel is desired to be large so that a fuel spray flux nears the electrode part. Note that, the injection angle as used herein is defined as an angle between a center line of the fuel spray flux and a vertical line when a straight line that is parallel to a center line of the combustion chamber and passes through a tip of the fuel injector is coincident with the vertical line. However, the fuel spray flux comes to face a cylinder wall surface when the injection angle increases. As a result, an amount of the fuel attaching to the cylinder wall surface increases. This contributes to make oil dilution by the fuel accelerate and also contributes to increase the number of the discharge particles (PN).

Also, in the internal combustion engine disclosed in the above patent document, the two fuel spray fluxes sandwiching the electrode part of the spark plug have about the same distance to the electrode part from contour surfaces thereof. In this case, the effect entraining a discharge spark and an initial flame which are generated at the electrode part is generally equal between the two fuel spray fluxes. Therefore, an entrainment direction of the discharge spark and the initial flame is not fixed. A variation in the entrainment direction might decrease ignitionability of the fuel spray flux and cause unstable combustion.

The present disclosure is made in the light of the aforementioned problem, and has an object to realize stabilization of combustion by improving ignitionability while suppressing adhesion of fuel to a cylinder wall surface, in an internal combustion engine that is equipped with a spark plug and a fuel injector on a ceiling of a combustion chamber.

An internal combustion engine according to the present disclosure comprises a fuel injector that is disposed on a ceiling of a combustion chamber and is provided with at least more than three injection holes including a first injection hole and a second injection hole; and a spark plug that is disposed on the ceiling of the combustion chamber.

The fuel injector is configured so that each of fuel spray fluxes formed by the injection holes extends obliquely downward when a straight line that is parallel to a center line of the combustion chamber and passes through a tip of the fuel injector is coincident with a vertical line. Further, the fuel injector is configured so that, when seen from a top view of the combustion chamber, each of the fuel spray fluxes formed by the injection holes proceed to different directions respectively while sandwiching an electrode part of the spark plug by a first fuel spray flux formed by the first injection hole and a second fuel spray flux formed by the second injection hole. Further, the fuel injector is configured so that the electrode part is located outside of a contour surface of the first fuel spray flux and is located outside of a contour surface of the second fuel spray flux. Further, the fuel injector is configured so that a first injection angle that is an angle between a center line of the first fuel spray flux and the vertical line and a second injection angle that is an angle between a center line of the second fuel spray flux and the vertical line are larger than an angle between a center line of any other fuel spray flux and the vertical line.

In one embodiment, further, the fuel injector is configured to make the second injection angle smaller than the first injection angle so that a distance from the electrode part to the contour surface of the second fuel spray flux is larger than a distance from the electrode part to the contour surface of the first fuel spray flux. In this embodiment, the fuel injector may be configured so that, when seen from the top view of the combustion chamber, an angle between the center line of the second fuel spray flux and a straight line that links the tip of the fuel injector to the electrode part is smaller than an angle between the center line of the first fuel spray flux and the straight line.

In another embodiment, further, the fuel injector is configured to make a diameter of the second injection hole smaller than a diameter of the first injection hole so that a flow volume of the second fuel spray flux is smaller than a flow volume of the first fuel spray flux.

According to the internal combustion engine according to the present disclosure, each of the injection angles of the first fuel spray flux formed by the first injection hole and the second fuel spray flux formed by the second injection hole is made larger than the injection angle of any other fuel spray flux, and thereby distances from the electrode part of the spark plug to the contour surfaces of the two fuel spray fluxes sandwiching the electrode part are reduced. This increases an equivalence ratio of atmosphere around the electrode part to improve ignitionability. Further, because it is unnecessary to enlarge the injection angle of the fuel spray flux that does not act on the electrode part directly, adhesion of fuel to the cylinder wall surface is suppressed.

Further, according to the one embodiment, by making the second injection angle smaller than the first injection angle, the distance from the electrode part to the contour surface of the second fuel spray flux is made larger than the distance from the electrode part to the contour surface of the first fuel spray flux, and thereby an entraining effect by the second fuel spray flux is decreased relatively, so that the discharge spark and the initial flame are entrained by the first fuel spray flux. That is, an entrainment direction is fixed to a direction toward the first fuel spray flux, and thereby the ignitionability of the fuel spray flux is further improved and the combustion is stabilized. Further, according to the one embodiment, the second fuel spray flux proceeds downward than the first fuel spray flux, and thereby the adhesion of fuel to the cylinder wall surface is further suppressed.

Further, according to the another embodiment, by making the diameter of the second injection hole smaller than the diameter of the first injection hole, the flow volume of the second fuel spray flux is made smaller than the flow volume of the first fuel spray flux, and thereby an entraining effect by the second fuel spray flux is decreased relatively, so that the discharge spark and the initial flame are entrained by the first fuel spray flux. That is, an entrainment direction is fixed to a direction toward the first fuel spray flux, and thereby the ignitionability of the fuel spray flux is further improved and the combustion is stabilized. Further, according to the another embodiment, a reaching distance of the second fuel spray flux becomes shorter than a reaching distance of the first fuel spray flux, and thereby the adhesion of fuel to the cylinder wall surface is further suppressed.

### BRIEF DESCRIPTION OF DRAWINGS

FIG. 1 is a diagram illustrating a system configuration according to embodiments of the present disclosure;

FIG. 2 is a diagram illustrating an injection period of a fuel injector and a discharge period of a spark plug during a catalyst warm-up control;

FIG. 3 is a schematic diagram illustrating an operation of an internal combustion engine with a cylinder condition during the catalyst warm-up control;

FIG. 4 is a schematic top view of a combustion chamber showing a positional relationship between fuel spray fluxes and an electrode part of a spark plug according to a first embodiment;

FIG. 5 is a schematic side view of the combustion chamber showing injection angles of the fuel spray fluxes according to the first embodiment;

FIG. 6 is a schematic sectional view of A-A cross section in FIG.4 showing the positional relationship between the fuel spray fluxes and the electrode part according to the first embodiment;

FIG. 7 is a diagram illustrating a relationship between combustion stability and an injection angle of a fuel spray flux close to the spark plug;

FIG. 8 is a diagram illustrating a relationship between a fuel adhesion amount and an injection angle of a fuel spray flux close to the spark plug;

FIG. 9 is a schematic top view of a combustion chamber showing a positional relationship between fuel spray fluxes and an electrode part of a spark plug according to a modification of the first embodiment;

FIG. 10 is a schematic sectional view of B-B cross section in FIG.9 showing the positional relationship between the fuel spray fluxes and the electrode part according to the modification of the first embodiment;

FIG. 11 is a schematic top view of a combustion chamber showing a positional relationship between fuel spray fluxes and an electrode part of a spark plug according to a second embodiment;

FIG. 12 is a schematic sectional view of C-C cross section in FIG.11 showing the positional relationship between the fuel spray fluxes and the electrode part according to the second embodiment;

FIG. 13 is a diagram illustrating a relationship between combustion stability and an injection hole diameter of a fuel spray flux close to the spark plug; and

FIG. 14 is a diagram illustrating a relationship between a fuel adhesion amount and an injection hole diameter of a fuel spray flux close to the spark plug.

### DETAILED DESCRIPTION

Hereinafter, an embodiment of the present disclosure will be described with reference to the drawings. Note that when the numerals of the numbers, the quantities, the amounts, the ranges and the like of the respective elements are mentioned in the embodiment shown as follows, the present disclosure is not limited to the mentioned numerals unless specially explicitly described otherwise, or unless the disclosure is explicitly specified by the numerals theoretically. Further, the structures, steps and the like that are described in the embodiment shown as follows are not always indispensable to the disclosure unless specially explicitly shown otherwise, or unless the disclosure is explicitly specified by the structures, steps and the like theoretically.

### [Description of System Configuration]

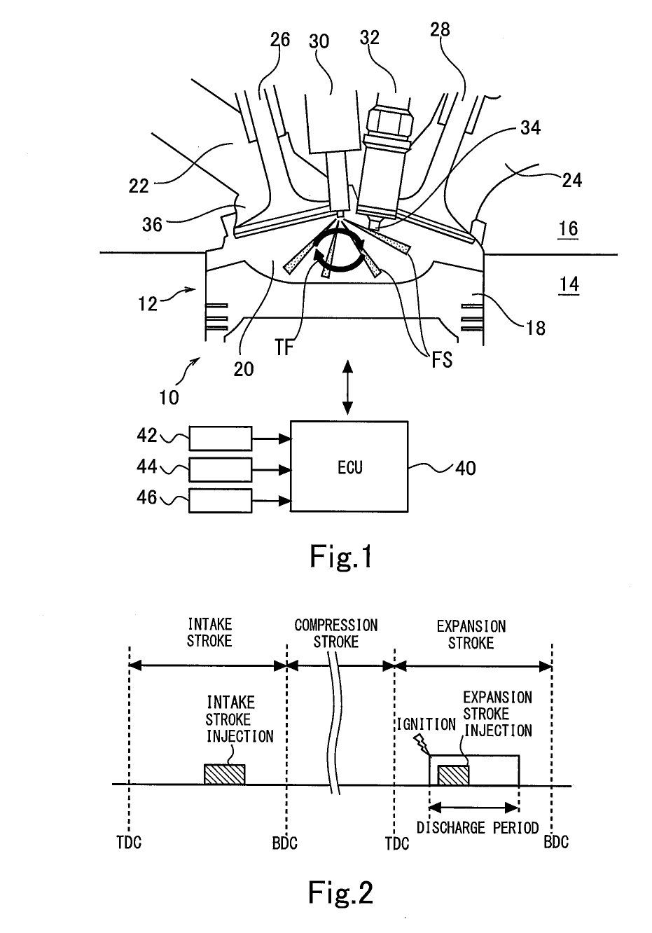

FIG. 1 is a diagram illustrating a system configuration according to the embodiment of the present application. As illustrated in FIG. 1, a system according to the present embodiment comprises an internal combustion engine 10 mounted in a vehicle. The internal combustion engine 10 is a four-stroke one-cycle engine. The internal combustion engine 10 has a plurality of cylinders, and one cylinder 12 is illustrated in FIG. 1. The internal combustion engine 10 comprises a cylinder block 14 in which the cylinder 12 is formed, and a cylinder head 16 disposed on the cylinder block 14. A piston 18 is disposed in the cylinder 12, the piston 18 reciprocatingly moving in an axial direction of the piston 18. A combustion chamber 20 of the internal combustion engine 10 is defined by a wall surface of the cylinder 12, a bottom surface of the cylinder head 16 (this corresponds to a ceiling surface of the combustion chamber 20), and a top surface of the piston 18.

Two intake ports 22 and two exhaust ports 24 which are communicated with the combustion chamber 20 are formed in the cylinder head 16. An intake valve 26 is provided in an opening of the intake port 22 which is communicated with the combustion chamber 20. An exhaust valve 28 is provided in an opening of the exhaust port 24 which is communicated with the combustion chamber 20. A spark plug 32 is provided so as to be located on the exhaust valve 28 side of the center of the ceiling of the combustion chamber 20. The spark plug 32 has an electrode part 34 at a tip thereof, the electrode part 34 comprising a center electrode and a ground electrode.

A fuel injector 30 is provided so that a tip of the fuel injector 30 faces the combustion chamber 20. The fuel injector 30 is located on the intake valve 26 side of the spark plug 32 around the center of the ceiling of the combustion chamber 20. However, the fuel injector 30 may be located at the center of the ceiling of the combustion chamber 20. The fuel injector 30 is connected to a fuel supply system comprising a fuel tank, a delivery pipe, a supply pump and the like, and is supplied with a high pressure fuel regulated to a constant pressure. The tip of the fuel injector 30 has a plurality of injection holes. When the fuel injector 20 opens, fuel is injected radially from these injection holes, and a plurality of fuel spray fluxes FS are formed which extend obliquely downward from the tip of the fuel injector 30. The direction of the injection holes is adjusted so that an electrode part 34 of the spark plug 32 is located outside a contour surface of the fuel spray flux which is closest to the spark plug 32 among the plurality of the fuel spray fluxes FS. The details about the fuel injector 30, especially, the details about the position of the injection holes, the direction of the fuel spray fluxes FS and so on will be described later.

The intake port 22 extends substantially straight from an inlet on an intake passage side toward the combustion chamber 20. A flow passage cross-sectional area of the intake port 22 is reduced at a throat 36 which is a connection part with the combustion chamber 20. Such a shape of the intake port 22 generates a tumble flow TF in intake air which flows from the intake port 22 into the combustion chamber 20. The tumble flow TF swirls in the combustion chamber 20 so as to proceed from the intake port 22 side to the exhaust port 24 side around the ceiling of the combustion chamber 20. Therefore, the spark plug 32 is located downstream of the fuel injector 30 in the flow direction of the tumble flow TF generated in the combustion chamber 20. A recess is formed on the top surface of the piston 18 forming the lower part of the combustion chamber 20 in order to conserve the tumble flow TF.

As illustrated in FIG. 1, the system according to the present embodiment comprises an ECU (Electronic Control Unit) 40 as a control device. The ECU 40 comprises a RAM (Random Access Memory), a ROM (Read Only Memory), a CPU (Central Processing Unit), and the like. The ECU 40 receives signals from various sensors mounted on the vehicle, and processes the received signals. The various sensors includes a combustion pressure sensor 42 disposed on the ceiling of the combustion chamber 20, a crank angle sensor 42 for measuring a rotation angle of a crankshaft connected to the piston 18, a temperature sensor 46 for measuring a temperature of coolant in the internal combustion engine 10 and so on. The ECU 40 processes the signals received from the individual sensors to operate various actuators according to a predetermined control program. The actuator operated by the ECU 40 comprises at least the fuel injector 30 and the spark plug 32 described above.

### [Description of Catalyst Warming-up Control]

In the present embodiment, the control for promoting the activation of an exhaust gas cleaning catalyst (hereinafter also referred to as “catalyst warming-up control”) is performed by the ECU 40 illustrated in FIG. 1 as control of the internal combustion engine 10. The exhaust gas cleaning catalyst is a catalyst which is provided in an exhaust passage of the internal combustion engine 10. An example of the exhaust gas cleaning catalyst is a three-way catalyst

At first, an outline of the catalyst warm-up control will be described with reference to FIG. 2 with FIG. 1. FIG. 2 shows an injection period of the fuel injector 30 and a discharge period of the spark plug 32 during the catalyst warm-up control. As shown in FIG. 2, the catalyst warm-up control adopts, for example, a fuel injection pattern that is a combination of an expansion stroke injection with an intake stroke injection as a main injection. Because a sufficient time is secured from the fuel injection timing to the ignition timing, the fuel injected by the intake stroke injection is diffused widely in the combustion chamber 20 by the tumble flow. Thereby, an air-fuel mixture with homogeneous fuel concentration is generated in the combustion chamber. A fuel injection amount by each stroke is decided so that an air-fuel ratio with all fuel including the expansion stroke injection becomes a theoretical air-fuel ratio. Therefore, the air-fuel ratio of the air-fuel mixture generated by the intake stroke injection is slightly leaner than the theoretical air-fuel ratio.

Also, as shown in FIG. 2, the discharge period of the spark plug 32 is set in a period of retard side than a compression top dead center during the catalyst warm-up control. That is, during the catalyst warm-up control, an ignition in the expansion stroke (hereinafter also referred to as an “expansion stroke ignition”) is performed. The expansion stroke ignition is performed to raise exhaust gas temperature. And the expansion stroke injection is performed in the discharge period of the spark plug 32. In more detail, the expansion stroke injection is started later than an initiation time of the discharge of the spark plug 32, and is finished earlier than an end time of the discharge. However, the initiation time of the discharge may coincide with the initiation time of the expansion stroke injection, or may be set later than the initiation time of the expansion stroke injection. The discharge should be started before at the latest the end of the expansion stroke injection. The reason to perform the expansion stroke injection in the discharge period is to burn the fuel injected by the expansion stroke injection surely by an entraining effect. Note that the end time of the discharge may coincide with the end time of the expansion stroke injection.

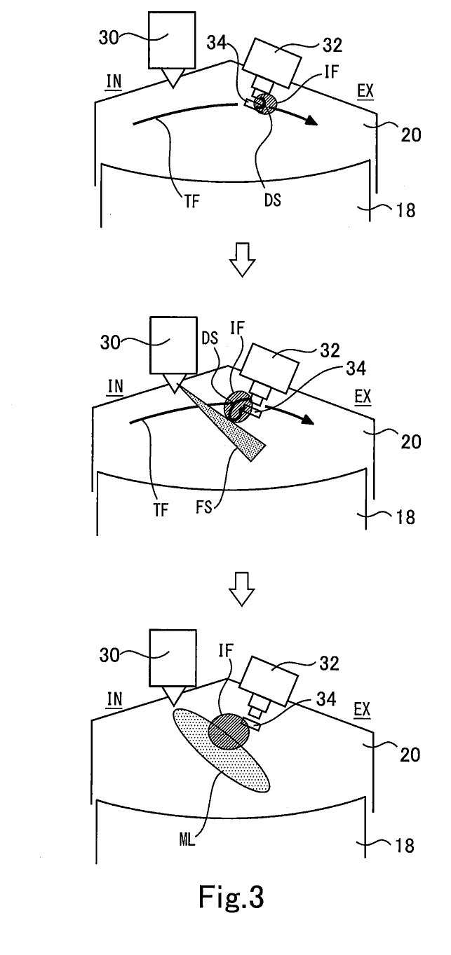

Next, a detail of the catalyst warm-up control and the effect thereof will be described with reference to FIG. 3. FIG. 3 schematically shows an operation of the internal combustion engine 10 with a cylinder condition during the catalyst warm-up control. A cylinder condition just after an initiation of the expansion stroke ignition is drawn in the upper section of FIG. 3. A cylinder condition just after an initiation of the expansion stroke injection is drawn in the middle section of FIG. 3. A cylinder condition after the expansion stroke injection is drawn in the lower section of FIG. 3. Note that, for convenience of the explanation, only the fuel spray flux FS most nearing the electrode part 34 of the spark plug 32 is shown in FIG. 3.

When the expansion stroke ignition is performed, an air-fuel mixture with an air-fuel ratio slightly leaner than the theoretical air-fuel ratio is generated by diffusion of fuel spray fluxes formed by the intake stroke injection. When the discharge is performed in this lean air-fuel ratio atmosphere, as shown in the upper section of FIG. 3, a discharge spark DS extending from the electrode part 34 ignites the air-fuel mixture, and an initial flame IF occurs. As shown in the middle section of FIG. 3, when a fuel is injected from the fuel injector 30 by the expansion stroke injection, the discharge spark DS and the initial flame IF are entrained to a direction toward the fuel spray flux FS by Coanda effect generated by the fuel spray flux FS. The initial flame IF entrained by the fuel spray flux FS grows up while involving the fuel spray flux FS formed by the expansion stroke injection. By the expansion stroke injection, as shown in the lower section of FIG. 3, a layer ML of an air-fuel mixture with high fuel concentration and high turbulence is formed in the combustion chamber 2. When the entrained initial flame IF reaches this layer ML, the flame grows at once, and the combustion progresses rapidly.

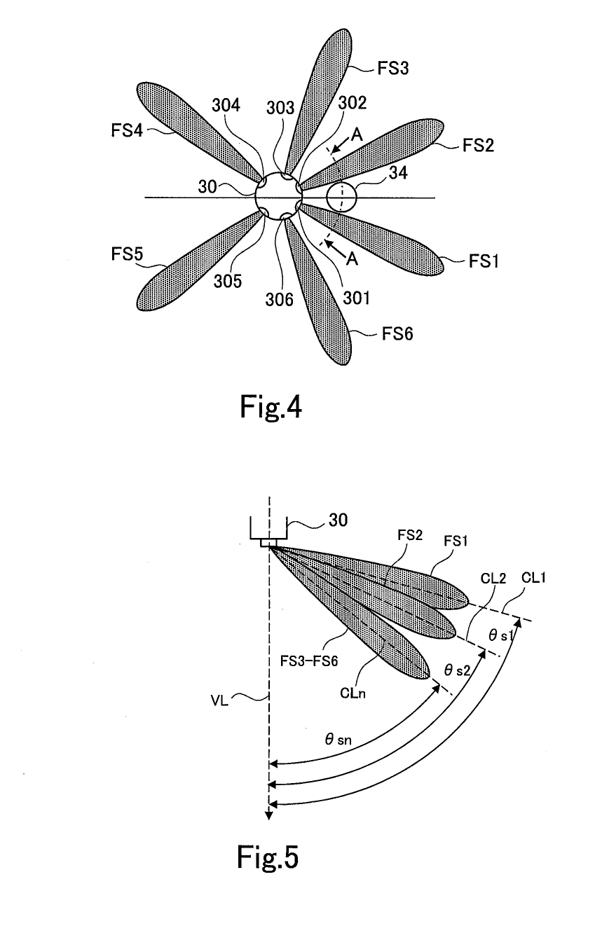

Descriptions about the system configuration common to all the embodiments of the present disclosure and the catalyst warm-up control performed by the ECU40 are as above. In the following, a characteristic configuration of each embodiment and effects thereof will be described with reference to FIGS. 4-14 with FIG. 1.

### Description of Characteristic Configuration of First Embodiment

FIG. 4 is a schematic top view of the combustion chamber showing a positional relationship between fuel spray fluxes and the electrode part of the spark plug according to a first embodiment. A plurality of injection holes are formed at the tip of the fuel injector 30. The number of formed injection holes is at least three. In FIG. 4, as an example, six injection holes 301-306 are formed. The position of each injection hole 301-306 is adjusted so that each of the fuel spray fluxes FS1-FS6 formed by the injection holes 301-306 proceed to different directions respectively while sandwiching the electrode part 34 of the spark plug by the first fuel spray flux FS1 formed by the first injection hole 301 and the second fuel spray flux FS2 formed by the second injection hole 302. In the first embodiment, the injection holes 301-306 have the same diameter and the fuel spray fluxes FS1-FS6 have nearly the same splay length. More specifically, concerning a straight line that passes through the tip of the fuel injector30 and the electrode part34, the first fuel spray flux FS1 and the second fuel spray flux FS2 are formed nearly line-symmetrically, the sixth fuel spray flux FS6 and the third fuel spray flux FS3 are formed nearly line-symmetrically, and the fourth fuel spray flux FS4 and the fifth fuel spray flux FS5 are formed nearly line-symmetrically.

FIG. 5 is a schematic side view of the combustion chamber showing injection angles of the fuel spray fluxes according to the first embodiment. Specifically, in this schematic side view, the fuel spray fluxes FS1-FS6 formed by each injection holes are projected rotationally on the same plane with a rotation axis. The rotation axis is a straight line that is parallel to a center line of the combustion chamber and passes through the tip of the fuel injector 30. As shown in this schematic side view, when the straight line that is parallel to the center line of the combustion chamber and passes through the tip of the fuel injector 30 is coincident with a vertical line VL, each of the fuel spray fluxes FS1-FS6 formed by the injection holes extends obliquely downward.

Here, an angle θs1 between the center line CL1 of the first fuel spray flux FS1 and the vertical line VL is defined as an injection angle of the first fuel spray flux FS1 (hereinafter also referred to as a “first injection angle”). Also, an angle θs2 between the center line CL2 of the second fuel spray flux FS2 and the vertical line VL is defined as an injection angle of the second fuel spray flux FS2 (hereinafter also referred to as a “second injection angle”). As shown in FIG. 4, the first fuel spray flux FS1 and the second fuel spray flux FS2 are fuel spray fluxes sandwiching the electrode part 34 of the spark plug from both sides when seen from the top view of the combustion chamber. The first injection angle θs1 and the second injection angle θs2 are set larger than an angle θsn between the center line CLn of the other fuel spray fluxes FS3-FS6 and the vertical line VL. That is, the first and second fuel spray fluxes FS1, FS2 are injected upward than the other fuel spray fluxes FS3-FS6. Note that, in FIG. 5, injection angles of the four fuel spray fluxes FS3-FS6 are the same angle θsn, but they are illustrated like so for convenience sake and differ each other in reality. However, injection angles of the fuel spray fluxes FS3-FS6 are necessarily smaller than the first injection angle θs1 and the second injection angle θs2.

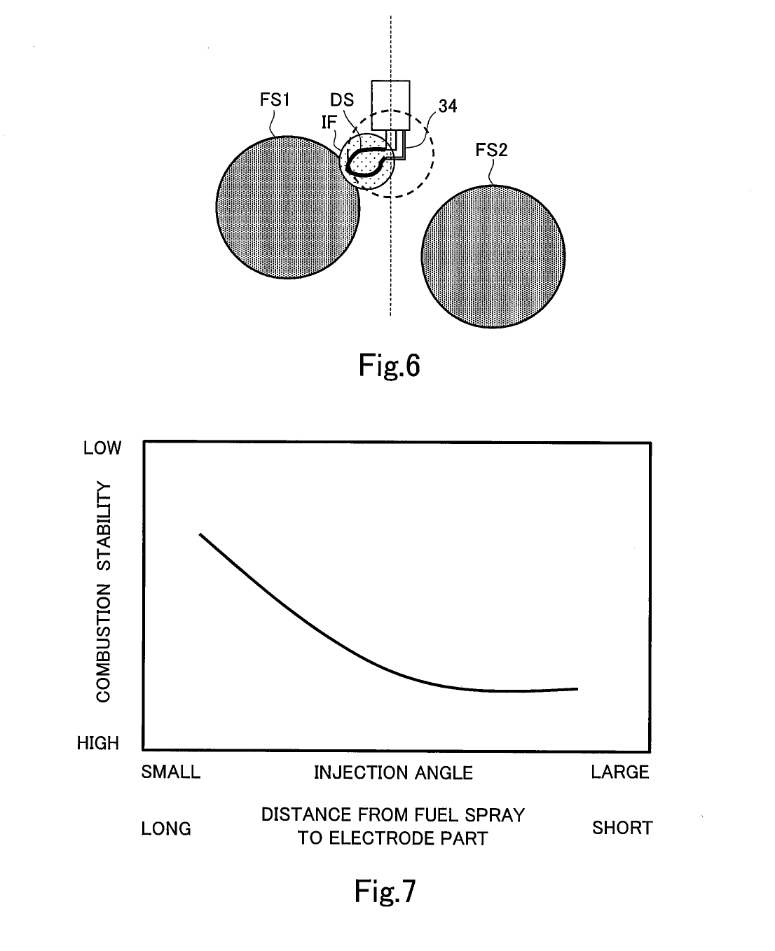

When comparing the first injection angle θs1 and the second injection angle θs2, the second injection angle θs2 is smaller than the first injection angle θs1. Here, FIG. 6 is a schematic sectional view of A-A cross section in FIG. 4. The first fuel spray flux FS1 and the second fuel spray flux FS2 are formed nearly line-symmetrically concerning the straight line that passes through the tip of the fuel injector30 and the electrode part34 (cf. FIG. 4). Therefore, by making the second injection angle θs2 smaller than the first injection angle θs1, a distance from the electrode part 34 to the contour surface of the second fuel spray flux FS2 becomes larger than a distance from the electrode part 34 to the contour surface of the first fuel spray flux FS1. Note that, the distance from the electrode part 34 to the contour surface of the first fuel spray flux FS1 means, strictly speaking, the shortest distance on the flat surface that is perpendicular to the center line of the first fuel spray flux FS1 and passes the center of the electrode part 34. Also, the distance from the electrode part 34 to the contour surface of the second fuel spray flux FS2 means, strictly speaking, the shortest distance on the flat surface that is perpendicular to the center line of the second fuel spray flux FS2 and passes the center of the electrode part 34.

An entraining airflow that is generated by Coanda effect by the fuel spray flux and entrains the discharge spark DS and the initial flame IF toward the fuel spray flux becomes large as the distance from the electrode part 34 to the contour surface of the fuel spray flux is small. Thus, by making the second injection angle θs2 smaller than the first injection angle θs1, and making the distance from the electrode part 34 to the contour surface of the second fuel spray flux FS2 larger than the distance from the electrode part 34 to the contour surface of the first fuel spray flux FS1, an entraining effect by the second fuel spray flux FS2 is decreased relatively and thereby the discharge spark DS and the initial flame IF are entrained by the first fuel spray flux FS1.

An entrainment direction of the discharge spark DS and the initial flame IF is fixed to a direction toward the first fuel spray flux FS1. Thereby, the ignitionability of the fuel spray flux is improved and the combustion is stabilized. Further, by making the second injection angle θs2 smaller than the first injection angle θs1, the second fuel spray flux FS2 proceeds downward than the first fuel spray flux FS1 and thereby the adhesion of fuel to the cylinder wall surface is suppressed.

Note that, as shown in FIG. 5, the injection angle θs2 of the second fuel spray flux FS2 is set smaller than the injection angle θs1 of the first fuel spray fluxFS1, but is set larger than the injection angles of the other fuel spray fluxes FS3-FS6. This setting is designed to raise an equivalence ratio of the atmosphere around the electrode part 34 and improve the ignitionability. The equivalence ratio of the atmosphere around the electrode part 34 is influenced by the first fuel spray flux FS1 and the second fuel spray flux FS2. As the distance from the electrode part 34 to the second fuel spray flux FS2 becomes large, the equivalence ratio of the atmosphere around the electrode part 34 becomes small, so that the ignitionability decreases. On the other hand, when the second fuel spray flux FS2 is brought too close to the electrode part 34, the entrainment direction of the discharge spark DS and the initial flame IF wavers between the first fuel spray flux FS1 and the second fuel spray flux FS2 and thereby the ignitionability rather decreases. Thus, in the first embodiment, the injection angle θs2 of the second fuel spray flux FS2 is set as above in order to suppress variation of the entrainment direction of the discharge spark DS and the initial flame IF while maintaining the equivalence ratio of the atmosphere around the electrode part 34 highly at some extent.

Here, FIG. 7 is a diagram illustrating a relationship between combustion stability and the injection angle θs2 of the fuel spray flux FS2. The combustion stability improves as the injection angle θs2 increases until the injection angle θs2 becomes larger than a certain angle. This is because, in accordance with the approach of the second fuel spray flux FS to the electrode part 34 of the spark plug, the entraining effect increases and also the equivalence ratio of the atmosphere around the electrode part 34 increases. However, when the injection angle θs2 becomes larger than a certain angle, variation of the entrainment direction occurs between the first fuel spray flux FS1 and the second fuel spray flux FS2 as described above. Therefore, even if the injection angle θs2 is made larger and approaches to the injection angle θs1 of the first fuel spray flux FS1, the combustion stability no longer improves, or it will rather decrease. Note that, a decrease of the combustion stability means an increase of the combustion variation rate. The combustion variation rate can be defined as a ratio of a standard deviation of an indicated mean effective pressure to an average thereof.

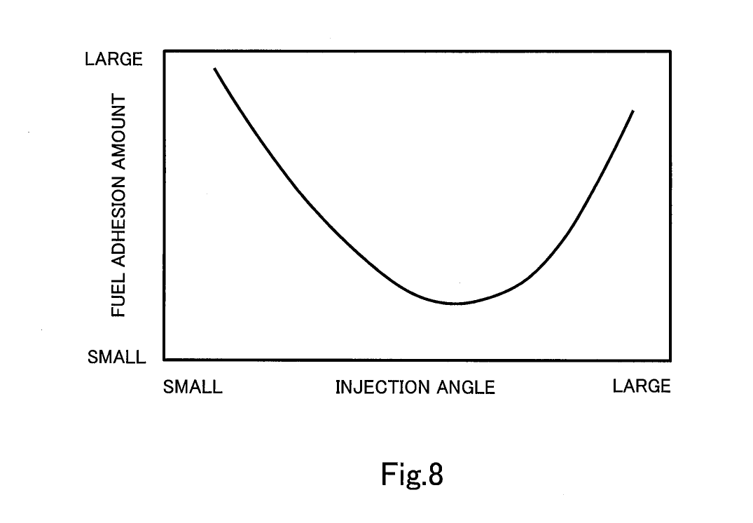

FIG. 8 is a diagram illustrating a relationship between a fuel adhesion amount and the injection angle θs2 of the fuel spray flux FS2. The term “fuel adhesion amount” used here designates a total amount of a fuel including a fuel attaching to the piston and a fuel attaching to the cylinder wall surface. The fuel adhesion amount of the cylinder wall surface by the second fuel spray flux FS2 becomes small as the injection angle θs2 becomes small. On the other hand, the fuel adhesion amount of the piston becomes large as the injection angle θs2 becomes small. As a result, the total fuel adhesion amount changes quadratically in accordance with the decrease of the injection angle θs2 of the second fuel spray flux FS2.

The injection angle θs2 of the second fuel spray flux FS2 is determined in detail based on consideration about the combustion stability and consideration about the fuel adhesion amount as described above.

### Description of Characteristic Configuration of Modified First Embodiment

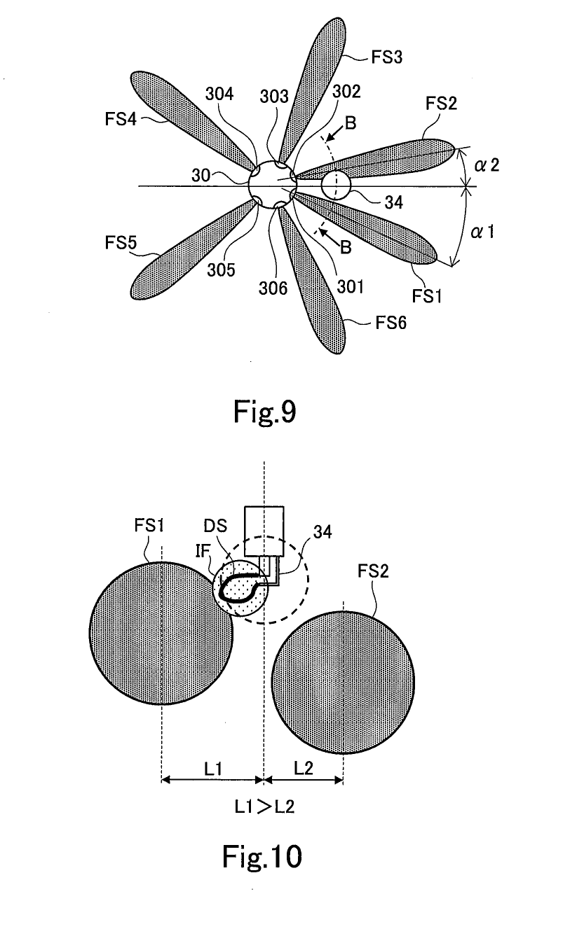

The first embodiment 1 may be modified as follows. FIG. 9 is a schematic top view of the combustion chamber showing a positional relationship between fuel spray fluxes and the electrode part of the spark plug according to a modification of the first embodiment. In this modification, when seen from the top view of the combustion chamber, an angle α2 between the center line of the second fuel spray flux FS2 and a straight line that links the tip of the fuel injector 30 to the electrode part 34 is made smaller than an angle α1 between the center line of the first fuel spray flux Fs1 and the straight line that links the tip of the fuel injector 30 to the electrode part 34.

By setting the angles α 1, α 2 of the fuel spray fluxes FS1, Fs2 in a periphery direction of the combustion chamber as discussed above, the positional relationship between the fuel spray fluxes FS1, Fs2 and the electrode part 34 becomes as shown in FIG. 10 in B-B cross section along in FIG. 9. That is, a distance L2 from the center of the second fuel spray flux FS2 to a center line of the electrode part 34 becomes smaller than a distance L1 from the center of the first fuel spray flux FS1 to the center line of the electrode part 34.

As a result, a distance from the electrode part 34 to the contour surface of the second fuel spray flux FS2 decreases than that of the first embodiment, so that the entraining effect by the second fuel spray flux FS2 to the discharge spark DS and the initial flame IF increases. However, because the first fuel spray flux FS1 remains nearer the electrode part34 than the second fuel spray flux FS2, the fear that the entrainment direction of the discharge spark DS and the initial flame IF is varied is small regardless of the increase of the entraining effect by the second fuel spray flux FS2. Rather, by the second fuel spray flux FS2 nearing the first fuel spray flux FS1, the entraining effect by the second fuel spray flux FS2 is superposed on the entraining effect by the first fuel spray flux FS1, so that the effect entraining the discharge spark DS and the initial flame IF to the first fuel spray flux FS1 becomes large. Further, the fuel adhesion amount by the second fuel spray flux FS2 remains as it is because the injection angle θs2 of the second fuel spray flux FS2 is not changed. That is, according to this modification, the combustion stability is improved more while suppressing the increase of the fuel adhesion amount.

### Description of Characteristic Configuration of Second Embodiment

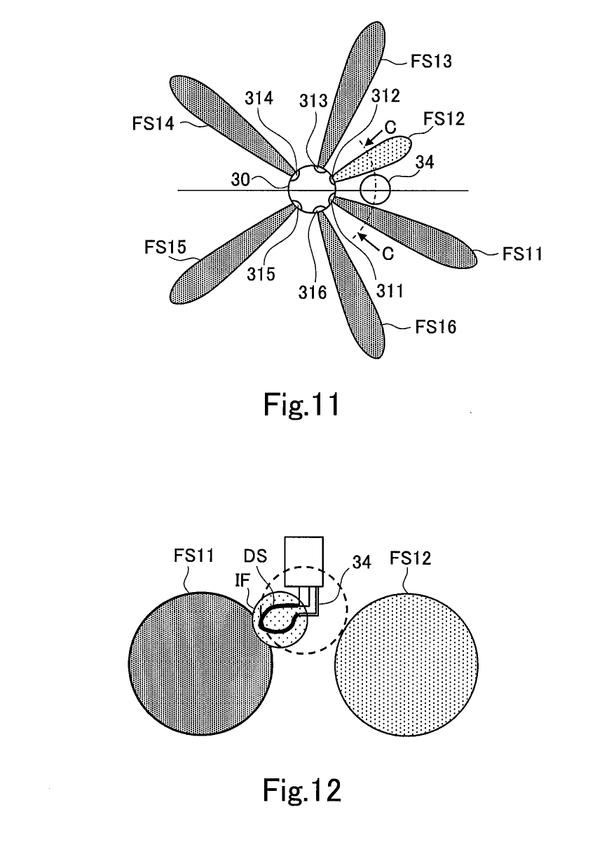

FIG. 11 is a schematic top view of the combustion chamber showing a positional relationship between fuel spray fluxes and the electrode part of the spark plug according to a second embodiment. A plurality of injection holes are formed at the tip of the fuel injector 30. The number of formed injection holes is at least three. In FIG. 11, as an example, six injection holes 311-316 are formed. The position of each injection hole 311-316 is adjusted so that each of the fuel spray fluxes FS11-FS16 formed by the injection holes 311-316 proceed to different directions respectively while sandwiching the electrode part 34 of the spark plug by the first fuel spray flux FS11 formed by the first injection hole 311 and the second fuel spray flux FS12 formed by the second injection hole 312. In the second embodiment, only the second injection hole 312 has a diameter smaller than those of the other injection holes 301, 303-306. When an injection hole has a small diameter, a flow volume of a fuel injected from the injection hole is small, and a fuel reaching distance, that is a splay length of a fuel spray flux, is short. Therefore, a splay length of the second fuel spray flux FS12 is shorter than those of the other fuel spray fluxes FS11, FS13-FS16.

Next, directions of the fuel spray fluxes FS11-FS6 will be described. The first fuel spray flux FS11 and the second fuel spray flux FS12 are formed nearly line-symmetrically concerning the straight line that passes through the tip of the fuel injector30 and the electrode part34. Also, the sixth fuel spray flux FS16 and the third fuel spray flux FS13 are formed nearly line-symmetrically, and the fourth fuel spray flux FS14 and the fifth fuel spray flux FS15 are formed nearly line-symmetrically. Further, though illustration is omitted, each of the fuel spray fluxes FS11-FS16 formed by the injection holes extends obliquely downward when a straight line that is parallel to the center line of the combustion chamber and passes through the tip of the fuel injector 30 is coincident with the vertical line. More specifically, the injection angle of the first fuel spray flux FS1 and the injection angle of the second fuel spray flux FS2 are the same angle, and larger than those of the other fuel spray fluxes FS13-FS16. That is, the first and the second fuel spray fluxes FS11, FS12 are injected with the same injection angle more upward than the other fuel spray fluxes FS13-FS16.

FIG. 12 is a schematic sectional view of C-C cross section in FIG.11. In FIG. 11, a difference in a flow volume between the first fuel spray flux FS11 and the second fuel spray flux FS12 is expressed by a difference in a density of dots. An entraining airflow that is generated by Coanda effect by the fuel spray flux and entrains the discharge spark DS and the initial flame IF toward the fuel spray flux becomes large as the flow volume becomes large when the distance from the electrode part 34 to the contour surface of the fuel spray flux is the same. Thus, by making the diameter of the second injection hole 312 smaller than the diameter of the first injection hole 311, and making the flow volume of the second fuel spray flux FS2 smaller than the flow volume of the first fuel spray flux FS1, an entraining effect by the second fuel spray flux FS2 is decreased relatively and thereby the discharge spark DS and the initial flame IF are entrained by the first fuel spray flux FS1.

An entrainment direction of the discharge spark DS and the initial flame IF is fixed to a direction toward the first fuel spray flux FS1. Thereby, the ignitionability of the fuel spray flux is improved and the combustion is stabilized. Further, because the reaching distance of the second fuel spray flux FS12 becomes shorter than the reaching distance of the first fuel spray flux FS11, the adhesion of fuel to the cylinder wall surface is suppressed.

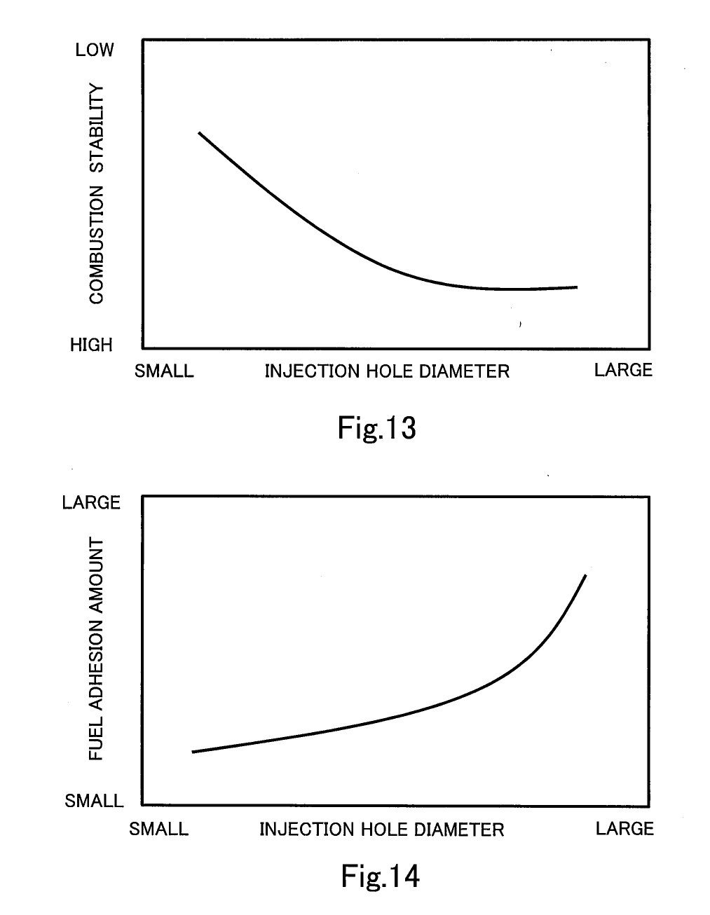

Here, FIG. 13 is a diagram illustrating a relationship between combustion stability and the diameter of the second injection hole 312. The combustion stability improves as the diameter of the second injection hole 312 increases until the diameter becomes larger than a certain size. This is because, in accordance with the increase of the flow volume of the second fuel spray flux FS12, the entraining effect increases and also the equivalence ratio of the atmosphere around the electrode part 34 increases. However, when the diameter of the second injection hole 312 becomes larger than a certain size, variation of the entrainment direction occurs between the first fuel spray flux FS1 and the second fuel spray flux FS2 as described above. Therefore, even if the diameter of the second injection hole 312 is made larger and approaches to the diameter of the first injection hole 311, the combustion stability no longer improves, or it will rather decrease.

FIG. 14 is a diagram illustrating a relationship between a fuel adhesion amount and the diameter of the second injection hole 312. The term “fuel adhesion amount” used here designates a total amount of a fuel including a fuel attaching to the piston and a fuel attaching to the cylinder wall surface. The fuel adhesion amount by the second fuel spray flux FS2 becomes small as the diameter of the second injection hole 312 becomes small.

The diameter of the second injection hole 312 is determined in detail based on consideration about the combustion stability and consideration about the fuel adhesion amount as described above.

### Other Embodiment

The configuration of the fuel injector of the first embodiment or the modification thereof may be combined with the configuration of the fuel injector of the second embodiment or the modification thereof. That is, the fuel injector may be configured to make the second injection angle smaller than the first injection angle so that a distance from the electrode part to the contour surface of the second fuel spray flux is larger than a distance from the electrode part to the contour surface of the first fuel spray flux, and to make the diameter of the second injection hole smaller than the diameter of the first injection hole so that the flow volume of the second fuel spray flux is smaller than the flow volume of the first fuel spray flux.

Note that, in each embodiment, a positional relationship between the second injection hole and the first injection hole or a positional relationship between the second fuel spray flux and the first fuel spray flux may be reversed concerning a straight line that links the tip of the fuel injector to the electrode part. For example, in the first embodiment, each injection angle may be set so that the left-side fuel spray flux in FIG. 6 is formed apart from the electrode part than the right-side fuel spray flux. In the second embodiment, each injection hole diameter may be set so that the flow rate of the left-side fuel spray flux in FIG. 12 becomes smaller than the flow rate of the right-side fuel spray flux.

What is claimed is:

1. An internal combustion engine comprising:
a fuel injector that is disposed on a ceiling of a combustion chamber and is provided with at least more than three injection holes including a first injection hole and a second injection hole; and
a spark plug that is disposed on the ceiling of the combustion chamber,
wherein the fuel injector is configured so that
each of fuel spray fluxes formed by the injection holes extends obliquely downward when a straight line that is parallel to a center line of the combustion chamber and passes through a tip of the fuel injector is coincident with a vertical line,
when seen from a top view of the combustion chamber, each of the fuel spray fluxes formed by the injection holes proceed to different directions respectively while sandwiching an electrode part of the spark plug by a first fuel spray flux formed by the first injection hole and a second fuel spray flux formed by the second injection hole, and
the electrode part is located outside of a contour surface of the first fuel spray flux and is located outside of a contour surface of the second fuel spray flux;
wherein the fuel injector is configured so that a first injection angle that is an angle between a center line of the first fuel spray flux and the vertical line and a second injection angle that is an angle between a center line of the second fuel spray flux and the vertical line are larger than an angle between a center line of any other fuel spray flux and the vertical line; and
wherein the fuel injector is configured to make the second injection angle smaller than the first injection angle so that a distance from the electrode part to the contour surface of the second fuel spray flux is larger than a distance from the electrode part to the contour surface of the first fuel spray flux.

2. The internal combustion engine according to claim 1,
wherein the fuel injector is configured so that, when seen from the top view of the combustion chamber, an angle between the center line of the second fuel spray flux and a straight line that links the tip of the fuel injector to the electrode part is smaller than an angle between the center line of the first fuel spray flux and the straight line.

3. An internal combustion engine comprising:
a fuel injector that is disposed on a ceiling of a combustion chamber and is provided with at least more than three injection holes including a first injection hole and a second injection hole; and
a spark plug that is disposed on the ceiling of the combustion chamber,
wherein the fuel injector is configured so that
each of fuel spray fluxes formed by the injection holes extends obliquely downward when a straight line that is parallel to a center line of the combustion chamber and passes through a tip of the fuel injector is coincident with a vertical line,
when seen from a top view of the combustion chamber, each of the fuel spray fluxes formed by the injection holes proceed to different directions respectively while sandwiching an electrode part of the spark plug by a first fuel spray flux formed by the first injection hole and a second fuel spray flux formed by the second injection hole, and
the electrode part is located outside of a contour surface of the first fuel spray flux and is located outside of a contour surface of the second fuel spray flux;
wherein the fuel injector is configured so that a first injection angle that is an angle between a center line of the first fuel spray flux and the vertical line and a second injection angle that is an angle between a center line of the second fuel spray flux and the vertical line are larger than an angle between a center line of any other fuel spray flux and the vertical line; and
wherein the fuel injector is configured to make a diameter of the second injection hole smaller than a diameter of the first injection hole so that a flow volume of the second fuel spray flux is smaller than a flow volume of the first fuel spray flux.
